(19) United States
(12) Patent Application Publication
(10) Pub. No.: US 2024/0043689 A1
(43) Pub. Date: Feb. 8, 2024

(54) SEALANT COMPOSITION

(71) Applicant: DOW SILICONES CORPORATION, Midland, MI (US)

(72) Inventors: Tatiana DIMITROVA, Seneffe (BE); Anne-Marie VAN STIPHOUDT, Seneffe (BE)

(21) Appl. No.: 18/267,813

(22) PCT Filed: Dec. 20, 2021
(86) PCT No.: PCT/US21/64261

§ 371 Date: Jun. 16, 2023

Related U.S. Application Data
(60) Provisional application No. 63/129,072, filed on Dec. 22, 2020.

(51) Int. Cl. C08L 83/06; C08K 3/36; C09K 3/10; C08G 77/18; C09J 183/06; C08K 9/06

(52) U.S. Cl. CPC C08L 83/06; C08K 3/36; C09K 3/1018; C08G 77/18; C09J 183/06; C08K 9/06; C08K 2201/006

(57) ABSTRACT

A one-part room temperature vulcanisable (RTV) silicone composition is provided. The one-part RTV silicone composition comprises a polyorganosiloxane polymer comprising at least two hydrolysable groups per molecule, anhydrous reinforcing filler(s), cross-linker(s), a tin (iv) based condensation catalyst and one or more low molecular weight linear or branched nitrogen containing compounds. The compounds are selected from amidines, guanidines and other alkyl amines and alkyl polyamines. The composition is designed to be storable for at least 6 months at a temperature (T° C.) in a range of between 0° C. and 25° C. inclusive.

This relates to a one-part room temperature vulcanisable (RTV) silicone composition comprising a polyorganosiloxane polymer comprising at least two hydrolysable groups per molecule, a tin (iv) based catalyst and one or more low molecular weight linear or branched nitrogen containing compounds. The composition is designed to be storable for at least 6 months at a temperature in a range of between 0° C. and 25° C. inclusive.

Room temperature vulcanizable (RTV) silicone rubber compositions (hereinafter referred to as “RTV compositions”) are well known. Generally, such compositions comprise an —OH end-blocked diorganopolysiloxane polymer or an alkoxy end-blocked polydiorganosiloxane which may have an alkylene link between the end silicon atoms. They are usually condensation curable and therefore also contain and one or more suitable cross-linking agents designed to react with the —OH and/or alkoxy groups and thereby cross-link the composition to form an e.g., elastomeric sealant product usually but not absolutely always in combination with one or more condensation cure catalysts. One or more additional ingredients such as reinforcing fillers, non-reinforcing fillers, adhesion promotors, diluents (e.g., plasticisers and/or extenders), chain extenders, flame retardants, solvent resistant additives, biocides and the like are often also incorporated into these compositions as and when required. They may be one-part compositions or multiple-part, e.g., two-part compositions.

One-part condensation curing silicone compositions are generally utilised to generate skin or diffusion cured silicone elastomers. It is well known to people skilled in the art that alkoxy titanium compounds and/or alkoxy zirconium compounds i.e., alkyl titanates—are suitable catalysts for curing such one component moisture curable silicones (References: Noll, W.; Chemistry and Technology of Silicones, Academic Press Inc., New York, 1968, p. 399, Michael A. Brook, silicon in organic, organometallic and polymer chemistry, John Wiley & sons, Inc. (2000), p. 285). One-part condensation curing silicone compositions are generally designed not to contain any water/moisture in the composition so far as possible, i.e., they are generally stored in a substantially anhydrous form to prevent premature cure during storage before use. Such one-part condensation curing silicone compositions are applied in a layer that is thinner than typically 15 mm. Such compositions applied in layers thicker than 15 mm are known to lead to uncured material in the depth of the material, because the moisture is very slow to diffuse in very deep sections. Skin or diffusion cure (e.g., moisture/condensation) takes place by the formation of a cured skin at the composition/air interface subsequent to the sealant/encapsulant being applied on to a substrate surface. Subsequent to the generation of the surface skin the cure speed is dependent on the speed of diffusion of moisture from the sealant/encapsulant interface with air to the inside (or core) of the layer of silicone composition applied, and the diffusion of condensation reaction by-product/effluent from the inside (or core) to the outside (or surface) of the material and the gradual thickening of the cured skin over time from the outside/surface to the inside/core. The main, if not sole source, of moisture in these compositions are the inorganic fillers, e.g., silica when present. Said fillers may be rendered anhydrous before inter-mixing with other ingredients or water/moisture may be extracted from the mixture during the mixing process to ensure that the resulting sealant composition is substantially anhydrous.

Silicone sealant compositions having at least one Si-alkoxy bond, e.g., Si-methoxy bond in the terminal reactive silyl group and having a polydiorganosiloxane polymeric backbone are widely used for sealants in the construction industry because they have good adhesion, and weather resistance, and the like. The construction industry also prefers one-component compositions to negate the need for mixing ingredients before application and compositions with excellent workability.

Multi-component compositions designed to activate condensation cure in the bulk of e.g. silicone sealant layer generally rely on the use of other catalysts such as tin or zinc-based catalysts, e.g., dibutyl tin dilaurate, tin octoate and/or zinc octoate (Noll, W. Chemistry and Technology of Silicones, Academic Press Inc., New York, 1968, p. 397). In silicone compositions stored before use in two or more parts, one part contains a filler which typically contains the moisture required to activate condensation cure in the bulk of the product. Unlike the previously mentioned diffusion cure one-part system, two-part condensation cure systems, once mixed together, enable bulk cure even in sections greater than 15 mm in depth. In this case the composition will cure (subsequent to mixing) throughout the material bulk. If a skin is formed, it will be only in the first minutes after application. Soon after, the product will become a solid in the entire mass.

This disclosure relates to a one-part room temperature vulcanisable (RTV) silicone composition which as an alternative to the usual titanium or zirconium based catalysts relies on a low level of a tin (iv) based catalyst in combination with a primary or secondary organic amine which composition is storable for at least 6 months at a temperature in a range of between 0° C. and 25° C. inclusive and which upon cure provides a transparent or translucent sealant.

There is provided herein a one-part condensation curable room temperature vulcanisable (RTV) silicone composition comprising
(a) an organopolysiloxane polymer having at least two hydroxyl or hydrolysable groups per molecule of the formula

X₃₋ₙRₙSi-(Z)_{d}-(O)_{q}—(R¹_{y}SiO_{(4-y)/2})_{z}—(SiR¹₂₋Z)_{d}-Si—RₙX₃₋ₙ (1)
in which each X is independently a hydroxyl group or a hydrolysable group, each R is an alkyl, alkenyl or aryl group, each R¹ is an X group, alkyl group, alkenyl group or aryl group and Z is a divalent organic group;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000mPa·s at 25° C., in an amount of from 35 to 90% by weight of the composition;
(b) one or more essentially anhydrous reinforcing filler(s);
(c) one or more cross-linkers in the form of a silicon containing compound having at least two, alternatively at least three hydrolysable groups per molecule;
(d) a tin (iv) based condensation catalyst in an amount of from 0.001 to 0.1 inclusive % by weight of the composition (wt. %); and
(e) one or more low molecular weight linear or branched nitrogen containing compounds selected from amidines, guanidines and other alkyl amines and alkyl polyamines in an amount of 0.1-3.5% by weight (wt. %) of the composition.

The composition is storable for at least 6 months at a temperature in a range of between 0° C. and 25° C. inclusive in moisture-tight containers, e.g., cartridges and/or pails. By moisture-tight containers, we mean containers which prevent the ingress of moisture. The resulting compositions have a transparent and/or translucent appearance. For the avoidance of doubt, the terms % by weight of the composition and wt. % are intended to have the same meaning and are used interchangeably throughout.

Compositions of this type are deemed shelf stable if:
1. the skin over time (SOT) and Tack free time (TFT) do not increase more than 3-fold compared to initial values determined upon compounding, while being stored in a closed cartridge; and
2. if the resulting cured material has retained at least 75% of the tensile strength (expressed via tensile strength measured on H-bars or dumbbells) compared to initial values determined upon compounding and the hardness of the cured material (expressed as Shore A) should also be retained.

There is also provided herein a method of making the above composition by mixing all the ingredients together. There is also provided herein an elastomeric sealant material which is the cured product of

the composition as hereinbefore described.

There is also provided a use of the aforementioned composition as a sealant in the facade, insulated glass, window construction, automotive, solar and construction fields.

There is also provided a method for filling a space between two substrates so as to create a seal therebetween, comprising:
a) providing a silicone composition as hereinbefore described, and either
b) applying the silicone composition to a first substrate, and bringing a second substrate in contact with the silicone composition that has been applied to the first substrate, or
c) filling a space formed by the arrangement of a first substrate and a second substrate with the silicone composition and
d) curing the silicone composition.

The concept of “comprising” where used herein is used in its widest sense to mean and to encompass the notions of “include” and “consist of”.

For the purpose of this application “substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

The compositions are preferably room temperature vulcanisable compositions in that they cure at room temperature without heating but may if deemed appropriate be accelerated by heating.

Organopolysiloxane polymer (a) having at least two hydroxyl or hydrolysable groups per molecule has the formula

X₃₋ₙRₙSi-(Z)_{d}-(O)_{q}—(R¹_{y}SiO_{(4-y)/2})_{z}—(SiR¹₂₋Z)_{d}-Si—RₙX₃₋ₙ (1)
in which each X is independently a hydroxyl group or a hydrolysable group, each R is an alkyl, alkenyl or aryl group, each R¹ is an X group, alkyl group, alkenyl group or aryl group and Z is a divalent organic group;
d is 0 or 1, q is 0 or 1 and d+q=1; n is 0, 1, 2 or 3, y is 0, 1 or 2, and z is an integer such that said organopolysiloxane polymer (a) has a viscosity of from 30,000 to 150,000 mPa·s at 25° C., alternatively from 40,000 to 140,000 mPa·s at 25° C., in accordance with Corporate test method CTM 0050, which is publicly available, and which is based on ASTM D 1084-16 method B, using a Brookfield HBDV-III Ultra Rheometer equipped with a cone-and-plate geometry using spindle 52. All viscosity measurements herein are taken at 25° C. unless otherwise indicated. Alternatively, the viscosity may be measured using a Modular Compact Rheometer (MCR) 302 rheometer from Anton Paar GmbH of Graz. Austria with the most suitable settings and plates for the viscosity concerned. For example, viscosities in the range of 30,000-160,000 mPa·s may be measured using the MCR³⁰² rheometer with a 40 mm diameter cone-plate and a shear rate of 1 s⁻¹; viscosities in the range 2000-30,000 mPa·s may be measured using the MCR³⁰² rheometer with a 50 mm diameter cone-plate and a shear rate of is 1 s⁻¹; and viscosities in the range 10-2000 mPa·s may be measured using the MCR 302 rheometer with a 75 mm diameter cone-plate and a shear rate of is 1 s⁻¹.

Each X group of organopolysiloxane polymer (a) may be the same or different and can be a hydroxyl group or a condensable or hydrolyzable group. The term “hydrolyzable group” means any group attached to the silicon which is hydrolyzed by water at room temperature. The hydrolyzable group X includes groups of the formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃.

The most preferred X groups are hydroxyl groups or alkoxy groups. Illustrative alkoxy groups are methoxy, ethoxy, propoxy, isopropoxy, n-butoxy, t-butoxy, isobutoxy, pentoxy, hexoxy octadecyloxy and 2-ethylhexoxy; dialkoxy groups, such as methoxymethoxy or ethoxymethoxy and alkoxyaryloxy, such as ethoxyphenoxy groups. The most preferred alkoxy groups are methoxy or ethoxy groups. When d=1, n is typically 0 or 1 and each X is an alkoxy group, alternatively an alkoxy group having from 1 to 3 carbons, alternatively a methoxy or ethoxy group. In such a case organopolysiloxane polymer (a) has the following structure:

X₃₋ₙRₙSi-(Z)-(R¹_{y}SiO_{(4-y)/2})_{z}—(SiR¹₂₋Z)-Si—RₙX₃₋ₙ

with R, R¹, Z, y and z being the same as previously identified above, n being 0 or 1 and each X being an alkoxy group.

Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups aminoalkyl groups, polyaminoalkyl groups, and/or epoxyalkyl groups.

Each R¹ is individually selected from the group consisting of X or R with the proviso that cumulatively at least two X groups and/or R¹ groups per molecule are hydroxyl or hydrolysable groups. It is possible that some R¹ groups may be siloxane branches off the polymer backbone which branches may have terminal groups as hereinbefore described. Most preferred R¹ is methyl.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group.

Additionally n is 0, 1, 2 or 3, d is 0 or 1, q is 0 or 1 and d+q=1. In one alternatively when q is 1, n is 1 or 2 and each X is an OH group or an alkoxy group. In another alternative when d is 1 n is 0 or 1 and each X is an alkoxy group.

Organopolysiloxane polymer (a) has a viscosity of from 30,000 to 150,000 mPa·s at 25° C., alternatively from 40,000 to 140,000 mPa·s at 25° C. with the viscosities determined using one of the methods as described above; z is therefore an integer enabling such a viscosity, alternatively z is an integer from 300 to 5000. Whilst y is 0, 1 or 2, substantially y=2, e.g., at least 90%, alternatively 95% of R¹_{y}SiO_{(4-y)/2} groups are characterized with y=2.

Organopolysiloxane polymer (a) can be a single siloxane represented by Formula (1) or it can be mixtures of organopolysiloxane polymers represented by the aforesaid formula. Hence, the term “siloxane polymer mixture” in respect to organopolysiloxane polymer (a) is meant to include any individual organopolysiloxane polymer (a) or mixtures of organopolysiloxane polymer (a).

The Degree of Polymerization (DP), (i.e., in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by gel permeation chromatography (GPC) with precision of about 10-15% using polystyrene standards. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity. In the present disclosure the number average molecular weight and weight average molecular weight values of component (a) herein may, for example, be determined using a Waters 2695 Separations Module equipped with a vacuum degasser, and a Waters 2414 refractive index detector (Waters Corporation of MA, USA). The analyses may then be performed using certified grade toluene flowing at 1.0 mL/min as the eluent. Data collection and analyses may be performed using Waters Empower GPC software.

Organopolysiloxane polymer (a) is present in the composition in an amount of from 35 to 90% by weight of the composition, alternatively 40 to 90%, alternatively 45 to 90% by weight of the composition.

The reinforcing filler (b) maybe exemplified by essentially anhydrous fumed silica and/or a precipitated silica which in each case is preferably in a finely divided form. By essentially anhydrous we mean that a small amount of moisture may remain in the filler as it is almost impossible for it to be 100% anhydrous but that the filler is preferred to be as practically anhydrous as it can be.

Precipitated silica, fumed silica and/or colloidal silicas are particularly preferred because of their relatively high surface area, which is typically at least 50 m²/g (BET method in accordance with ISO 9277: 2010). Fillers having surface areas of from 50 to 450 m²/g (BET method in accordance with ISO 9277: 2010), alternatively of from 50 to 400 m²/g (BET method in accordance with ISO 9277: 2010), are typically used. All these types of silica are commercially available.

Typically such reinforcing fillers are naturally hydrophilic (e.g., untreated silica fillers) and are therefore usually treated with a treating agent to render them hydrophobic. These surface modified reinforcing fillers do not clump and can be homogeneously incorporated into the polyorganosiloxane of component (a), as the surface treatment makes the fillers easily wetted by component (a).

The reinforcing fillers (b) may be surface treated with any low molecular weight organosilicon compounds disclosed in the art applicable to make the fillers easier to handle and obtain a homogeneous mixture with the other ingredients and prevent creping of organosiloxane compositions during processing. For example, organosilanes, polydiorganosiloxanes, or organosilazanes e.g., hexaalkyl disilazane, short chain siloxane diols to render the filler(s) hydrophobic and therefore easier to handle and obtain a homogeneous mixture with the other ingredients. Specific examples include, but are not restricted to, silanol terminated trifluoropropylmethylsiloxane, silanol terminated vinyl methyl (ViMe) siloxane, silanol terminated methyl phenyl (MePh) siloxane, liquid hydroxyldimethyl-terminated polydiorganosiloxane containing an average from 2 to 20 repeating units of diorganosiloxane in each molecule, hydroxyldimethyl terminated Phenylmethyl Siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi(trifluoropropyl)disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlrotrimethyl silane, dichlrodimethyl silane, trichloromethyl silane.

A small amount of water can be added together with the silica treating agent(s) as processing aid.

The surface treatment may take place before introduction of the fillers into the composition or alternatively may be undertaken in-situ, usually during the preparation of a base material substantially comprising polyorganosiloxane component (a) and said fillers.

The surface treatment may take place before introduction of the fillers into the composition or alternatively may be undertaken in-situ, usually during the preparation of a base material substantially comprising polyorganosiloxane component (a) and said fillers (b).

The reinforcing filler is present in an amount of from 2.5 to 40% by weight (wt. %) of the composition, alternatively of from 5.0 to 35wt. % of the composition, alternatively of from 5 to 20 wt. % of the composition, alternatively of from 7.0 to 15wt. % of the composition, alternatively from 7 to 12% by weight of the composition, alternatively from 7 to 11% by weight of the composition.

Component (c) is one or more cross-linkers comprising a silicon containing compound having at least two alternatively at least three hydroxyl and/or hydrolysable groups per molecule. Component (c) is effectively functioning as a cross-linker and as such requires a minimum of 2 hydrolysable groups per molecule and preferably 3 or more. Component (c) may have two hydrolysable groups when component (a) has three or more hydroxyl or hydrolysable groups per molecule. Component (c) may thus have two but alternatively has three or more silicon-bonded condensable (preferably hydroxyl and/or hydrolysable) groups per molecule which are reactive with the silanol groups in component (a).

Typically, component (c) may be
one or more silanes having at least 2 hydrolysable groups, alternatively at least 3 hydrolysable groups per molecule group; and/or
one or more silyl functional molecules having at least 2 silyl groups, each silyl group containing at least one hydrolysable group.

For the sake of the disclosure herein a disilyl functional molecule comprises two silicon atoms each having at least one hydrolysable group, where the silicon atoms are separated by an organic chain or a siloxane chain not described above. Typically, each silyl groups on the disilyl functional molecule may be terminal groups. The spacer may be a polymeric chain.

The hydrolysable groups on the silyl groups may be selected from acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy). In some instances, the hydrolysable group may include hydroxyl groups. Alternatively, said hydrolysable groups on the silyl groups are selected from acyloxy groups; alkoxy groups and/alkenyloxy groups.

When component (c) is a silane, said silanes may include alkoxy functional silanes, oximosilanes, acetoxy silanes, acetonoxime silanes and/or enoxy silanes. Preferably when component (c) is a silane, said silanes may include alkoxy functional silanes, acetoxy silanes, acetonoxime silanes and/or enoxy silanes with alkoxy functional silanes most preferred.

When component (c) is a silane and when the silane has only three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. The fourth silicon-bonded organic groups may be methyl.

A typical silane may be described by formula (8)

R″₄₋ᵣSi(OR⁵)ᵣ (8)

wherein R⁵ is described below and r has a value of 2, 3 or 4. Typical silanes are those wherein R″ represents methyl, ethyl or vinyl or isobutyl. R″ is an organic radical selected from linear and branched alkyls, allyls, phenyl and substituted phenyls, acetoxy, oxime. In some instances, R⁵ represents methyl or ethyl and r is 3.

Another type of suitable silanes for component (c) are molecules of the type Si(OR⁵)₄ where R⁵ is as described below, alternatively propyl, ethyl or methyl. Partial condensates of Si(OR⁵)₄ may also be considered.

In a further embodiment component (c) is a silyl functional molecule having at least 2 silyl groups each having at least 1 and up to 3 hydrolysable groups, alternatively each silyl group has at least 2 hydrolysable groups.

Component (c) may be a disilyl functional polymer, that is, a polymer containing two silyl groups, each containing at least one hydrolysable group such as described by the formula (4)

(R⁶O)ₘ(Y¹)₃₋ₘ—Si(CH₂)ₓ—((NHCH₂CH₂)ₜ-Q(CH₂)ₓ)ₛ—Si(OR⁶)ₘ)(Y₁)₃₋ₘ (4)

where R⁶ is a C₁₋₁₀ alkyl group, Y¹ is an alkyl groups containing from 1 to 8 carbons, Q is a chemical group containing a heteroatom with a lone pair of electrons e.g., an amine, N-alkylamine or urea; each x is an integer of from 1 to 6, t is 0 or 1; each m is independently 1, 2 or 3 and s is 0 or 1.

When component (c) is a disilyl functional polymer, the polymer may have an organic polymeric backbone. The polymeric backbone of a silyl (e.g., disilyl) functional component (c) may be organic, i.e., component (c) may comprise organic based polymers with silyl terminal groups e.g., silyl polyethers, silyl acrylates and silyl terminated polyisobutylenes. In the case of silyl polyethers the polymer chain is based on polyoxyalkylene based units. Such polyoxyalkylene units preferably comprise a linear predominantly oxyalkylene polymer comprised of recurring oxyalkylene units, (—CₙH₂ₙ—O—) illustrated by the average formula (—CₙH₂ₙ—O—)_{y} wherein n is an integer from 2 to 4 inclusive and y is an integer of at least four. Likewise, the viscosity will be ≤1000 at 25° C. mPa·s, alternatively 250 to 1000 mPa·s at 25° C. alternatively 250 to 750 mPa·s at 25° C. and will have a suitable number average molecular weight of each polyoxyalkylene polymer block present. The viscosity may be measured using any suitable means e.g., a Modular Compact Rheometer (MCR) 302 from Anton Paar GmbH of Graz, Austria using the most suitable settings and plates for the viscosity concerned as described above. Moreover, the oxyalkylene units are not necessarily identical throughout the polyoxyalkylene monomer but can differ from unit to unit. A polyoxyalkylene block or polymer, for example, can be comprised of oxyethylene units, (—C₂H₄—O—); oxypropylene units (—C₃H₆—O—); or oxybutylene units, (—C₄H₈—O—); or mixtures thereof.

Other polyoxyalkylene units may include for example: units of the structure

—[—R^{e}—O—(—R^{f}—O—)_{w}—Pn—CR^{g}₂—Pn—O—)_{q}—R^{e}]—

in which Pn is a 1,4-phenylene group, each R^{e} is the same or different and is a divalent hydrocarbon group having 2 to 8 carbon atoms, each R^{f} is the same or different and, is, an ethylene group or propylene group, each R^{g} is the same or different and is, a hydrogen atom or methyl group and each of the subscripts w and q is a positive integer in the range from 3 to 30.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

In the case of such organic based cross-linkers the molecular structure can be straight chained, branched, cyclic or macromolecular, i.e., an organic polymer chain bearing alkoxy functional end groups.

Whilst any suitable hydrolysable groups may be utilised, it is preferred that the hydrolysable groups are alkoxy groups and as such the terminal silyl groups may have the formula such as —R^{a}Si(OR^{b})₂, —Si(OR^{b})₃, —R^{a}₂SiOR^{b} or (R^{a})₂Si—R^{c}—SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl group having up to 6 carbon atoms; R^{c} is a divalent hydrocarbon group which may be interrupted by one or more siloxane spacers having up to six silicon atoms; and p has the value 0, 1 or 2. Typically each terminal silyl group will have 2 or 3 alkoxy groups.

Component (c) thus include alkyltrialkoxysilanes such as methyltrimethoxysilane (MTM) and methyltriethoxysilane, tetraethoxysilane, partially condensed tetraethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane, oximosilanes, acetoxy silanes, acetonoxime silanes, enoxy silanes and other such trifunctional alkoxysilanes as well as partial hydrolytic condensation products thereof; 1,6-bis(trimethoxysilyl)hexane (alternatively known as hexamethoxydisilylhexane), bis(trialkoxysilylalkyl)amines, bis (dialkoxyalkylsilylalkyl)amine, bis(trialkoxysilylalkyl)N-alkylamine, bis(dialkoxyalkylsilylalkyl) N-alkylamine, bis(trialkoxysilylalkyl)urea, bis(dialkoxyalkylsilylalkyl) urea, bis(3-trimethoxysilylpropyl)amine, bis(3-triethoxysilylpropyl)amine, bis(4-trimethoxysilylbutyl)amine, bis(4-triethoxysilylbutyl)amine, bis(3-trimethoxysilylpropyl)N-methylamine, bis(3-triethoxysilylpropyl)N-methylamine, bis(4-trimethoxysilylbutyl)N-methylamine, bis(4-triethoxysilylbutyl) N-methylamine, bis(3-trimethoxysilylpropyl)urea, bis(3-triethoxysilylpropyl)urea, bis(4-trimethoxysilylbutyl)urea, bis(4-triethoxysilylbutyl)urea, bis (3-dimethoxymethylsilylpropyl)amine, bis(3-diethoxymethyl silylpropyl)amine, bis(4-dimethoxymethylsilylbutyl)amine, bis(4-diethoxymethyl silylbutyl)amine, bis(3-dimethoxymethylsilylpropyl)N-methylamine, bis(3-diethoxymethyl silylpropyl)N-methylamine, bis(4-dimethoxymethylsilylbutyl)N-methylamine, bis(4-diethoxymethyl silylbutyl)N-methylamine, bis(3-dimethoxymethylsilylpropyl)urea, bis(3-diethoxymethyl silylpropyl)urea, bis(4-dimethoxymethylsilylbutyl)urea, bis(4-diethoxymethyl silylbutyl)urea, bis(3-dimethoxyethylsilylpropyl)amine, bis(3-diethoxyethyl silylpropyl)amine, bis(4-dimethoxyethylsilylbutyl)amine, bis(4-diethoxyethyl silylbutyl)amine, bis(3-dimethoxyethylsilylpropyl)N-methylamine, bis(3-diethoxyethyl silylpropyl)N-methylamine, bis(4-dimethoxyethylsilylbutyl)N-methylamine, bis(4-diethoxyethyl silylbutyl)N-methylamine, bis(3-dimethoxyethylsilylpropyl)urea bis(3-diethoxyethyl silylpropyl)urea, bis(4-dimethoxyethylsilylbutyl)urea and/or bis(4-diethoxyethyl silylbutyl)urea; bis(triethoxysilylpropyl)amine, bis (trimethoxysilylpropyl)amine, bis(trimethoxysilylpropyl)urea, bis(triethoxysilylpropyl)urea, bis (diethoxymethylsilylpropyl)N-methylamine; di or trialkoxy silyl terminated polydialkyl siloxane, di or trialkoxy silyl terminated polyarylalkyl siloxanes, di or trialkoxy silyl terminated polypropyleneoxide, polyurethane, polyacrylates; polyisobutylenes; di or triacetoxy silyl terminated polydialkyl; polyarylalkyl siloxane; di or trioximino silyl terminated polydialkyl; polyarylalkyl siloxane; di or triacetonoxy terminated polydialkyl or polyarylalkyl. The component (c) used may also comprise any combination of two or more of the above.

When component (c) is one or more silanes or silyl functional molecules as described above they may be present in the composition in an amount of from 1 to 25% by weight (wt. %) of the composition.

Said one or more silane cross-linkers having at least 3 hydroxyl and/or hydrolysable groups per molecule (c), when present, may be selected from a silane having the structure

R⁸ⱼSi(OR⁵)₄₋ⱼ

As mentioned previously where each R⁵ may be the same or different and is hydrogen or an alkyl group containing at least one carbons, alternatively from 1 to 20 carbons, alternatively from 1 to 10 carbons alternatively from 1 to 6 carbons. The value of j is 0 or 1. Whilst each R⁵ group may be the same of different it is preferred that at least two R⁵ groups are the same, alternatively at least three R⁵ groups are the same and alternatively when j is 0 all R⁵ groups are the same. Hence, specific examples of the reactive silane (c) when j is zero include tetraethylorthosilicate, tetrapropylorthosilicate, tetra n-butylorthosilicate and tetra t-butylorthosilicate.

When j is 1 the group R⁸ is present. R⁸ is a silicon-bonded organic group selected from a substituted or unsubstituted straight or branched monovalent hydrocarbon group having at least one carbon, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group, an isocyanurate group or an isocyanate group. Unsubstituted monovalent hydrocarbon groups, suitable as R⁸, may include alkyl groups e.g., methyl, ethyl, propyl, and other alkyl groups, alkenyl groups such as vinyl, cycloalkyl groups may include cyclopentane groups and cyclohexane groups. Substituted groups suitable in or as R⁸, may include, for the sake of example, 3-hydroxypropyl groups, 3-(2-hydroxyethoxy)alkyl groups, halopropyl groups, 3-mercaptopropyl groups, trifluoroalkyl groups such as 3,3,3-trifluoropropyl, 2,3-epoxypropyl groups, 3,4-epoxybutyl groups, 4,5-epoxypentyl groups, 2-glycidoxyethyl groups, 3-glycidoxypropyl groups, 4-glycidoxybutyl groups, 2-(3,4-epoxycyclohexyl) ethyl groups, 3-(3,4-epoxycyclohexyl)alkyl groups, aminopropyl groups, N-methylaminopropyl groups, N-butylaminopropyl groups, N,N-dibutylaminopropyl groups, 3-(2-aminoethoxy)propyl groups, methacryloxyalkyl groups, acryloxyalkyl groups, carboxyalkyl groups such as 3-carboxypropyl groups, 10-carboxydecyl groups.

Specific examples of suitable silane cross-linkers having at least 3 hydroxyl and/or hydrolysable groups per molecule (c), include but are not limited to vinyltrimethoxysilane, methyltrimethoxysilane, ethyltriethoxysilane, ethyltrimethoxysilane, propyltriethoxysilane, isobutyltriethoxysilane, isobutyltrimethoxysilane, vinyltriethoxysilane, phenyltriethoxysilane, phenyltrimethoxysilane, methyltris(isopropenoxy)silane or vinyltris(isopropenoxy)silane, 3-hydroxypropyl triethoxysilane, 3-hydroxypropyl trimethoxysilane, 3-(2-hydroxyethoxy)ethyltriethoxysilane, 3-(2-hydroxyethoxy)ethyltrimethoxysilane, chloropropyl triethoxysilane, 3-mercaptopropyl triethoxysilane, 3,3,3-trifluoropropyl triethoxysilane, 2,3-epoxypropyl triethoxysilane, 2,3-epoxypropyl trimethoxysilane, 3,4-epoxybutyl triethoxysilane, 3,4-epoxybutyl trimethoxysilane, 4,5-epoxypentyl triethoxysilane, 4,5-epoxypentyl trimethoxysilane, 2-glycidoxyethyl triethoxysilane, 2-glycidoxyethyl trimethoxysilane, 3-glycidoxypropyl triethoxysilane, 3-glycidoxypropyl trimethoxysilane, 4-glycidoxybutyl triethoxysilane, 4-glycidoxybutyl trimethoxysilane, 2-(3,4-epoxycyclohexyl) ethyl triethoxysilane, 3-(3,4-epoxycyclohexyl)ethyl triethoxysilane, aminopropyl triethoxysilane, aminopropyl trimethoxysilane, N-methylaminopropyl triethoxysilane, N-methylaminopropyl trimethoxysilane, N-butylaminopropyl trimethoxysilane, N,N-dibutylaminopropyl triethoxysilane, 3-(2-aminoethoxy)propyl triethoxysilane, methacryloxypropyl triethoxysilane, tris(3-triethoxysilylpropyl) isocyanurate, acryloxypropyl triethoxysilane, 3-carboxypropyl triethoxysilane and 10-carboxydecyl triethoxysilane.

The one or more cross-linkers having at least 3 hydroxyl and/or hydrolysable groups per molecule (c) is present in an amount of from 0.1 to 5% by weight of the composition, present in an amount of from 0.5 to 4% by weight of the composition, alternatively in an amount of from 1 to 3.5% by weight of the composition, alternatively in an amount of from 1 to 3.5% by weight of the composition.

Component (d), the tin (iv) catalyst may be any suitable tin (iv) based condensation cure catalyst. Examples of suitable tin (iv) based catalysts include tin triflates, dialkyltin compounds, selected from dimethyltin di-2-ethylhexanoate, dimethyltin dilaurate, di-n-butyltin diacetate (DBTDA), di-n-butyltin di-2-ethylhexanoate, dimethyltin dineodecanoate (DMTDN), dioctyltin dineodecanoate (DOTDN), di-n-butyltin dicaprylate, di-n-butyltin di-2,2-dimethyl octanoate, di-n-butyltin octanoate, di-n-butyltin dilaurate (DBTDL), di-n-butyltin distearate, di-n-butyltin dimaleate, di-n-butyltin dioleate, di-n-octyltin di-2-ethylhexanoate, di-n-octyltin di-2,2-dimethyl octanoate, di-n-octyltin dimaleate, Di-n-octyl tin dilaurate (DOTDL), di-n-butyl tin oxide, carbomethoxyphenyl tin trisuberate, tin butyrate, butyltintri-2-ethylhexoate, tin naphthenate, isobutyltintriceroate, tin octoate, triethyltin tartrate and di-n-octyl tin oxide. Said tin (iv) based condensation catalyst in an amount of from 0.001 to 0.1% inclusive by weight (wt. %) of the composition.

Component (e) is one or more low molecular weight linear or branched nitrogen containing compounds selected from amidines, guanidines and other alkyl amines and alkyl polyamines in an amount of 0.1-3.5% by weight (wt. %) of the composition, alternatively 0.1-1.5% by weight (wt. %) of the composition, alternatively 0.1-1.0% by weight (wt. %) of the composition. By low molecular weight we mean having a molecular weight of less than or equal to 1000 g/mol. The nitrogen containing compounds of component (e) are identified as linear or branched and as such exclude heterocyclic compounds such as cyclic guanidines and amidines for example Triazabicyclodecene (1,5,7-Triazabicyclo[4.4.0]dec-5-ene (TBD)) 7-Methyl-1,5,7-triazabicyclo[4.4.0]dec-5-ene (mTBD), 1,5-Diazabicyclo[4.3.0]non-5-ene (DBN) and/or 1,8-diazabicyclo[5.4.0]undec-7-ene (DBU) and other compounds containing heterocyclic nitrogen groups such as imidazoles and benzimidazoles.

Chemically, it is not certain how component (e) functions but its presence appears to in some way “boost” the catalytic nature of component (d) when present in such low amount, thereby enabling such small amounts of tin (iv) containing cure catalysts to successfully cure silicone sealant or the like compositions, whereas in the absence of the catalytic boost the amount of tin (iv) catalyst may not function sufficiently well. Component (e) may be one or more linear or, branched molecules selected from amidines, guanidines and other alkyl amines and alkyl polyamines or a mixture thereof.

The amidine or guanidine group may comprise linear or, branched molecules organic molecules containing one or more of the groups (1) to (4) depicted below.

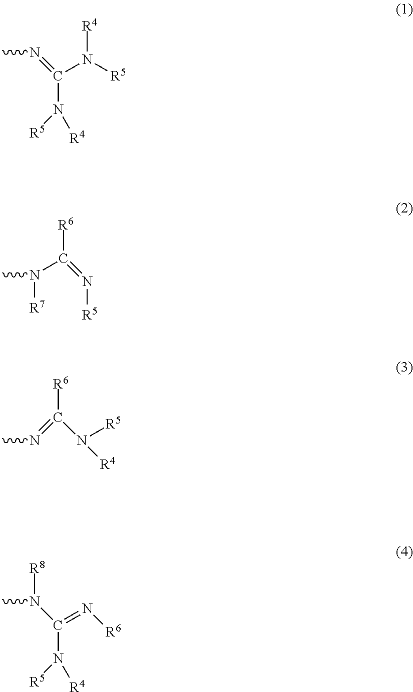

Wherein each R⁴, R⁵, R⁶, R⁷ and R⁸ may be the same or different and may be selected from hydrogen, an alkyl group, a cycloalkyl group, a phenyl group, an aralkyl group. or

Alternatively groups (1) to (4) may be bound to a linear or branched alkyl group comprising 1 to 20 carbons or to an aliphatic cyclic group directly or via an alkylene linkage, examples include guanidine, tetramethyl guanidine, e.g. 1,1,3,3-tetramethylguanidine (TMG) having the structure (CH₃)₂N—C═NH(N(CH₃)₂).

Alternatively, providing the molecular weight is less than or equal to 1000 g/mol one of structures (1) to (4) above may be linked to a polymer radical selected from a group consisting of alkyd resins, oil-modified alkyd resins, saturated or unsaturated polyesters, natural oils, epoxides, polyamides, polycarbonates, polyethylenes, polypropylenes, polybutylenes, polystyrenes, ethylene-propylene copolymers, (meth)acrylates, (meth)acrylamides and salts thereof, phenolic resins, polyoxymethylene homopolymers and copolymers, polyurethanes, polysulphones, polysulphide rubbers, nitrocelluloses, vinyl butyrates, vinyl polymers, ethylcelluloses, cellulose acetates and/or butyrates, rayon, shellac, waxes, ethylene copolymers, organic rubbers, polysiloxanes, polyethersiloxanes, silicone oligomers, polyethers, polyetheresters and/or polyether carbonates.

In a further alternative component (e) may be one or more alkyl polyamines such as dibutyl amine, ethylene diamine, tri-ethylene tertiary amine, diethylenetriamine, hexylamine, and dihexylamine or mixtures thereof.

Optional additives may be used if necessary. These may include non-reinforcing fillers, pigments, rheology modifiers, cure modifiers, and fungicides and/or biocides and the like; It will be appreciated that some of the additives may be included in more than one list of additives. Such additives would then have the ability to function in all the different ways referred to.

Non-reinforcing fillers, which might be used alone or in addition to the above include aluminite, calcium sulphate (anhydrite), gypsum, nepheline, svenite, quartz, calcium sulphate, magnesium carbonate, clays such as kaolin, ground calcium carbonate, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite.

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅.

The ring silicates group comprises silicate minerals, such as but not limited to, cordierite and Al₃(Mg,Fe)₂[Si₄l O₁₈]. The chain silicates group comprises ground silicate minerals, such as but not limited to, wollastonite and Ca[SiO₃].

The sheet silicates group comprises silicate minerals, such as but not limited to, mica; K₂AI₁₄[Si₆Al₂O₂₀](OH)₄; pyrophyllite; Al₄[Si₈O₂₀](OH₄; talc; Mg₆[Si₆O₂₀](OH₄); serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate ester, stearic acid, salts of stearic acid, calcium stearate and carboxylatepolybutadiene. Treating agents based on silicon containing materials may include organosilanes, organosiloxanes, or organosilazanes hexaalkyl disilazane or short chain siloxane diols to render the filler(s) hydrophobic and therefore easier to handle and obtain a homogeneous mixture with the other sealant components. The surface treatment of the fillers makes the ground silicate minerals easily wetted by the silicone polymer. These surface modified fillers do not clump and can be homogeneously incorporated into the silicone polymer. This results in improved room temperature mechanical properties of the uncured compositions. Furthermore, the surface treated fillers give a lower conductivity than untreated or raw material.

The composition of the invention can also include other ingredients known for use in moisture curable compositions based on silicon-bonded hydroxyl or hydrolysable groups such as sealant compositions.

Pigments are utilized to color the composition as required. Any suitable pigment may be utilized providing it is compatible with the composition. When present, carbon black will function as both a non-reinforcing filler and colorant and is present in a range of from 1 to 30% by weight of the catalyst package composition, alternatively from 1 to 20% by weight of the catalyst package composition; alternatively, from 5 to 20% by weight of the catalyst package composition, alternatively from 7.5 to 20% by weight of the catalyst composition.

Rheology modifiers which may be incorporated in moisture curable compositions according to the invention include silicone organic co-polymers such as those described in EP0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion to substrates, particularly plastic substrates.

Biocides may additionally be utilized in the composition if required. It is intended that the term “biocides” includes bactericides, fungicides and algicides, and the like. Suitable examples of useful biocides, which may be utilized in compositions as described herein, include, for the sake of example:

Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyppentan-3-ol and/or 1-[[2-(2,4-dichlorophenyl)-4-propyl-1,3-dioxolan-2-yl] methyl]-1H-1,2,4-triazole.

The fungicide and/or biocide may suitably be present in an amount of from 0 to 0.3% by weight of the composition and may be present in an encapsulated form where required such as described in EP2106418.

Hence, the one-part condensation curable room temperature vulcanisable (RTV) silicone composition herein may comprise
(a) an organopolysiloxane polymer having at least two hydroxyl or hydrolysable groups per molecule of the formula

X₃₋ₙRₙSi-(Z)_{d}-(O)_{q}—(R¹_{y}SiO_{(4-y)/2})_{z}—(SiR¹₂₋Z)_{d}-Si—RₙX₃₋ₙ (1)
in which each X is independently a hydroxyl group or a hydrolysable group, each R is an alkyl, alkenyl or aryl group, each RI is X group, alkyl group, alkenyl group or aryl group and Z is a divalent organic group;
d is 0 or 1, q is 0 or 1 and d+q=1; n is 0, 1, 2 or 3, y is 0, 1 or 2, and preferentially 2 and z is an integer such that said organopolysiloxane polymer has a viscosity of from 30,000 to 150,000 mPa·s at 25° C., alternatively from 40,000 to 140,000 mPa·s at 25° C. at 25° C., in an amount of from 35 to 90% by weight of the composition, alternatively 40 to 90%, alternatively 45 to 90% by weight of the composition.
(b) Precipitated silica, fumed silica and/or colloidal silicas are particularly preferred because of their relatively high surface area, which is typically at least 50 m²/g (BET method in accordance with ISO 9277: 2010). Fillers having surface areas of from 50 to 450 m²/g (BET method in accordance with ISO 9277: 2010), alternatively of from 50 to 400 m²/g (BET method in accordance with ISO 9277: 2010),
in an amount of from 2.5 to 40% by weight (wt. %) of the composition, alternatively of from 5.0 to % by weight (wt. %) of the composition, alternatively of from 5 to 20% by weight (wt. %) of the composition, alternatively of from 7.0 to 15% by weight (wt. %) of the composition, alternatively from 7 to 12% by weight of the composition, alternatively from 7 to 11% by weight of the composition;
(c) One or more cross-linkers having at least 3 hydroxyl and/or hydrolysable groups per molecule present in an amount of from 0.1 to 5% by weight of the composition, present in an amount of from to 4% by weight of the composition, alternatively in an amount of from 1 to 3.5% by weight of the composition, alternatively in an amount of from 1 to 3.5% by weight of the composition.
(d) a tin (iv) based condensation catalyst as hereinbefore described in an amount of from 0.001 to % by weight of the composition; and
(e) one or more low molecular weight nitrogen containing compounds selected from amidines, guanidines and other linear or branched alkyl amines and linear or branched alkyl polyamines in an amount of 0.1-3.75% by weight of the composition alternatively 0.1-1.5 wt. % alternatively 0.1-1.0% by weight (wt. %) of the composition. The composition is storable for at least 6 months at a temperature in a range of between 0° C. and 25° C. inclusive in moisture-tight containers, e.g., cartridges and/or pales. The resulting compositions have a transparent to translucent appearance.

The composition may comprise any combination of the above providing that the total composition of ingredients (a) to (e) together with any other optional ingredients included in the composition has a value of 100% by weight of the composition.

There is also provided herein a method of making the above one-part condensation curable room temperature vulcanisable (RTV) silicone composition by mixing all the ingredients together. Preferably once mixed, unless to be used immediately, the composition is sealed in one or more moisture-tight containers and is stored at a temperature in a range of between 0° C. and 25° C. inclusive therein. In one embodiment filler (b) is first mixed into the polymer (a), optionally, if required in combination with a hydrophobic treating agent so that the filler is treated in situ during the mixing into the polymer. Once the filler is adequately mixed into the polymer (and if desired has been hydrophobically treated) then the remaining components are added to make the complete composition.

There is also provided herein an elastomeric sealant material which is the cured product of the one-part condensation curable room temperature vulcanisable (RTV) silicone composition as hereinbefore described.

There is also provided a use of the aforementioned one-part condensation curable room temperature vulcanisable (RTV) silicone composition as a sealant in the facade, insulated glass, window construction, automotive, solar and construction fields.

It was found that compositions as hereinbefore described are shelf stable because
1. the skin over time (SOT) and Tack free time (TFT) do not increase more than 3-fold compared to initial values determined upon compounding, while being stored in a closed cartridge; and
2. the resulting cured material has retained at least 75% of the tensile strength (expressed via tensile strength measured on H-bars or dumbbells) compared to initial values determined upon compounding and the hardness of the cured material (expressed as Shore A) should also be retained.

In one embodiment the one-part condensation curable room temperature vulcanisable (RTV) silicone composition herein may be designed to provide a low modulus sealant composition. For the purpose of this invention, “low modulus” sealants are defined according to ISO11600, second edition 2002 Oct. 1, section 4.3 Low modulus silicone sealant compositions are preferably “gunnable” i.e., they have a suitable extrusion capability i.e., a minimum extrusion rate of 10 ml/min as measured by ASTM C1183-04, alternatively 10 to 1000 mL/min, and alternatively 30 to 500 mL/min.

The one-part condensation curable room temperature vulcanisable (RTV) silicone composition may in such a case impart a movement capability to the post-cured sealant material.

The movement capability is greater than 25%, alternatively movement capability ranges from 25% to 50%, as measured by ASTM C719 -13.

The one-part condensation curable room temperature vulcanisable (RTV) silicone composition as hereinbefore described may be a gunnable sealant composition used for
(i) space/gap filling applications;
(ii) seal applications, such as sealing the edge of a lap joint in a construction membrane; or
(iii) seal penetration applications, e.g., sealing a vent in a construction membrane;
(iv) adhering at least two substrates together; and/or
(v) a laminating layer between two substrates to produce a laminate of the first substrate, the sealant product and the second substrate.
   In the case of (v) above when used as a layer in a laminate, the laminate structure produced is not limited to these three layers. Additional layers of cured sealant and substrate may be applied. The layer of gunnable sealant composition in the laminate may be continuous or discontinuous.

A one-part condensation curable room temperature vulcanisable (RTV) silicone composition as hereinbefore described may be applied on to any suitable substrate. Suitable substrates may include, but are not limited to, glass; concrete; brick; stucco; metals, such as aluminium, copper, gold, nickel, silicon, silver, stainless steel alloys, and titanium; ceramic materials; plastics including engineered plastics such as epoxies, polycarbonates, poly(butylene terephthalate) resins, polyamide resins, polyvinyl chloride (PVC) and blends thereof, such as blends of polyamide resins with syndiotactic polystyrene commercially available from The Dow Chemical Company, of Midland, Michigan, U.S.A., acrylonitrile-butadiene-styrenes, styrene-modified poly(phenylene oxides), poly(phenylene sulfides), vinyl esters, polyphthalamides, and polyimides; cellulosic substrates such as paper, fabric, and wood; and combinations thereof. When more than one substrate is used, there is no requirement for the substrates to be made of the same material. For example, it is possible to form a laminate of plastic and metal substrates or wood and plastic substrates. After application and cure the elastomeric sealant product is non-staining (clean) with respect to porous substrates like granite, limestone, marble, masonry, metal and composite panels.

Of particular note as proven in the following examples is the fact that this composition upon cure adheres to PVC substrates.

In the case of the one-part condensation curable room temperature vulcanisable (RTV) silicone composition as hereinbefore described, there is provided a method for filling a space between two substrates so as to create a seal therebetween, comprising:
a) providing a one-part condensation curable room temperature vulcanisable (RTV) silicone composition as hereinbefore described, and either
b) applying the the one-part condensation curable room temperature vulcanisable (RTV) silicone composition to a first substrate, and bringing a second substrate in contact with the silicone composition that has been applied to the first substrate, or
c) filling a space formed by the arrangement of a first substrate and a second substrate with the one-part condensation curable room temperature vulcanisable (RTV) silicone composition and
d) curing same.

The one-part condensation curable room temperature vulcanisable (RTV) silicone composition as hereinbefore described may therefore provide a silicone sealant which may be of a low-modulus type having high movement capabilities. Furthermore, the composition herein is clear, i.e., transparent and/or translucent and is non-staining (clean) on construction substrates which may or may not be porous, such as granite, limestone, marble, masonry, glass, metal and composite panels for use as a stain-resistant weather sealing sealant material for construction and the like applications.

The Low modulus nature of the silicone elastomer produced upon cure of the one-part condensation curable room temperature vulcanisable (RTV) silicone composition when designed to be low modulus described herein makes the elastomer effective at sealing joints which may be subjected to movement for any reason, because compared to other cured sealants (with standard or high modulus) lower forces are generated in the cured sealant body and transmitted by the sealant to the substrate/sealant interface due to expansion or contraction of the joint enabling the cured sealant to accommodate greater joint movement without failing cohesively or interfacially (adhesively) or cause substrate failure.

### EXAMPLES

All viscosity measurements were taken at 25° C. unless otherwise indicated. Unless otherwise indicated, all viscosities in the examples were measured using a Modular Compact Rheometer (MCR) 302 rheometer from Anton Paar GmbH of Graz, Austria. Viscosities in the range of 30,000-160,000 mPa·s were measured using a 40 mm diameter cone-plate and a shear rate of 1 s⁻¹; viscosities in the range 2000-30,000 mPa·s were measured with a 50 mm diameter cone-plate and a shear rate of 1 s⁻¹; and viscosities in the range 10-2000 mPa·s were measured with a 75 mm diameter cone-plate and a shear rate of 1 s⁻¹.

The following ingredients are referred to in the examples:
Polymer A: a tri-methoxy-terminated polydimethylsiloxane polymer with viscosity of 50,000 mPa·s;
Polymer B: a Tri-ethoxy/trimethyl terminated essentially linear polydimethylsiloxane polymer with viscosity of 115,000 mPa·s. The ratio of Tri-ethoxy ends to tri-methyl ends have been determined by NMR and corresponds to 85/15;
Polymer B-1: a Tri-methoxy/trimethyl terminated essentially linear polydimethylsiloxane polymer with viscosity of 123,000 mPa·s. The ratio of Tri-methoxy end groups to tri-methyl end groups were determined by NMR and correspond to 85/15;
Polymer C: Tri-ethoxy terminated, essentially linear polydimethylsiloxane polymer with viscosity of mPa·s;
Polymer D: Tri-methyl terminated, essentially linear polydimethylsiloxane polymer with viscosity of 100 mPa·s
Polymer E: Tri-methyl terminated, essentially linear polydimethylsiloxane polymer with viscosity of 1000 mPa·s
   The term “essentially” in the phrase “essentially linear polydimethylsiloxane” means that the polymer is in each case linear, in so far as we are aware, but it can't be 100% discounted that minor amounts of branching may have occurred during manufacture.
Aerosil® R972 is a hydrophobic fumed silica after treated with dimethyldichlorosilanes from Evonik with a specific surface area of 90-130 m²/g (supplier data);
Aerosil® R974 is a hydrophobic fumed silica after treated with dimethyldichlorosilanes based on a hydrophilic fumed silica with a specific surface area of 150-190 m²/g from Evonik (supplier data);
MTM is methyl-tri methoxysilane; DBTDL Dibutyltin dilaurate; DBTDN is Dimethyltin dineodecanoate; DBN is 1,5-Diazabicyclo(4.3.0)non-5-ene; DBU is 1,8-Diazabicyclo[5.4.0]undec-7-ene;
TnBT is tetra n-butyl titanate; and HMDZ is Hexamethyldisilazane.

Comparative compositions were prepared using the compositions depicted in Tables 1a and 1b.

TABLE 1a
Composition of comparative formulations

| | C1 | C2 | C3 | C4 | C5 | C6 |
|---|---|---|---|---|---|---|
| Polymer A | 27.228 | 86.861 | 87.145 | 87.432 | 27.174 | 27.422 |
| Polymer B | 58.994 | | | | 58.877 | 59.414 |
| MTM | 1.452 | 2.389 | 2.397 | 2.404 | 1.449 | 1.463 |
| 1,6-bis(trimethoxysilyl)hexane | 0.363 | | | | 0.362 | 0.366 |
| vinylmethyl-dimethoxysilane | 1.452 | | | | 1.449 | 1.463 |
| DBTDN | | 0.326 | 0.327 | 0.328 | | |
| DBTDL | 0.073 | | | | 0.072 | 0.073 |
| DBU | 0.272 | 0.326 | 0.327 | | 0.272 | 0.274 |
| aminopropyl-tri-ethoxysilane | 0.182 | 0.326 | | | 0.181 | 0.183 |
| Aerosil ®R 972 | 9.076 | 8.686 | | | 9.058 | |
| Aerosil ®R 974 | | | 8.715 | 8.743 | | 8.227 |
| HMDZ | 0.908 | 1.086 | 1.089 | 1.093 | 0.906 | 0.914 |
| TnBT | | | | | 0.200 | 0.201 |

TABLE 1b
Composition of comparative formulations

| Ingredient | C7 | C8 | C9 | C10 | C11 | C12 | C13 |
|---|---|---|---|---|---|---|---|
| Polymer A | 27.396 | 27.522 | 27.397 | 27.523 | 18.348 | | |
| Polymer B | 59.358 | 59.629 | 59.362 | 59.633 | 68.803 | 86.754 | |
| Polymer C | | | | | | | 84.653 |
| MTM | 1.461 | 1.468 | 1.461 | 1.468 | 1.468 | 1.461 | 1.693 |
| 1,4-bis(trimethoxysilyl) hexane | 0.365 | 0.367 | 0.365 | 0.367 | 0.367 | 0.365 | 0.423 |
| vinylmethyl-dimethoxysilane | 1.461 | 1.468 | 1.461 | 1.468 | 1.468 | 1.461 | 1.693 |
| Aerosil ®R 974 | 8.219 | 8.257 | 8.219 | 8.257 | 8.257 | 8.219 | 9.523 |
| HMDZ | 0.913 | 0.459 | 0.913 | 0.459 | 0.459 | 0.913 | 1.058 |
| DBTDL | 0.078 | 0.078 | 0.073 | 0.073 | 0.078 | 0.078 | 0.09 |
| DBU | 0.274 | 0.275 | | | 0.275 | 0.274 | 0.317 |
| DBN | | | 0.274 | 0.275 | | | |
| TnBT | 0.201 | 0.202 | 0.201 | 0.202 | 0.202 | 0.201 | 0.233 |
| Aminopropyl-triethoxysilane | 0.274 | 0.275 | 0.274 | 0.275 | 0.275 | 0.274 | 0.317 |

Comparative examples (C1 to C4) were prepared in a series of initial experiments using a DAC 600.1vac-p Speed Mixer, equipped with a vacuum capability. First the polymer(s) were mixed with the HMDZ and then filler (silica) was added gradually until fully incorporated in the polymer(s). Subsequently the cross-linker(s), adhesion promoter(s) and optional additives are added and mixed into the composition. The catalyst and booster were then added and after further mixing the final composition was degassed to remove volatiles liberated during the process Immediately after compounding the resulting products (sealants) were transferred into moisture tight cartridges. One cartridge was kept at 90° C. and another was maintained at room temperature (20-23° C.).

Excepting example E10, the remaining examples, including comparatives (C5-C13) were prepared using the same mixing process but it was carried out in a 5 L batch mixer, equipped with mixing blades and vacuum capability. In C5-C13, unless stated otherwise, about 3 kg of material was produced per comparative and this was subsequently transferred to and stored in 330 mL sealant cartridges, which were sealed immediately after introduction to prevent ingress of moisture. Example E10 was made following a different process. Starting again with a double-wall kettle of the 5 L mixer the polymers were first added and then heated to a temperature of about 75° C. Then the trimethoxy silane, DBTDL, TMG and amino-silane were added and the resulting mixture was thoroughly mixed and degassed. The silica was then added in 3 approximately equal portions with mixing in between each addition until complete incorporation. This was followed by a further degassing step. Finally, the HMDZ was added and fully incorporated. The resultant sealant composition was degassed and drummed off.

Skin over time (SOT) and tack free time (TFT) for compositions C1-C4 are provided in Table 2a after being subjected to different storage conditions.

The SOT measurement is undertaken by first applying a 1-2 mm thick smear of the composition cast on a polyethylene sheet or Kraft paper. This is a rapid “finger test” repeated periodically (e.g., every 1-2 minutes) aimed to determine the minimum time needed for a surface skin to appear undertaken at room temperature (20-23° C.) and approximately 50% relative humidity (RH).

The TFT measurement is also undertaken by first applying a 1-2 mm thick smear of the composition cast on a polyethylene sheet or Kraft paper. A small, clean polyethylene (PE) ribbon is applied after set periods of time e.g., every 1-2 minutes and then is carefully withdrawn. The test is repeated in time on different positions of the smear and the TFT is deemed achieved when the ribbon detaches cleanly (i.e., “tack free”) from the surface of the smear.

Compositions were heat aged as a practical means of accelerating the ageing effect at room temperature (20-23° C.). In the majority of cases if a composition can withstanding 6 weeks (wks.) of ageing at 50° C. one can anticipate it will age adequately well at room temperature (20-23° C.) over a period of for 9-12 months. Similarly, 4 wks. storage at 50° C. is roughly equivalent to the effect of ageing at room temperature (20-23° C.) over a period of about 6 months. That said the physical results of samples tested in both ways will not necessarily result in the same physical properties after ageing. Testing on heat aged samples was only carried out after the cartridge holding the composition was cooled for at least 4 hours. The SOT and TFT of samples aged for 6 months at room temperature (RT) prior to curing are also provided.

TABLE 2
SOT and TFT times (min.) during cure of comparative
formulations prepared C1 to C4

| | C1 | C2 | C3 | C4 |
|---|---|---|---|---|
| SOT-initial | 37 | 30 | 42 | 149 |
| TFT-initial | 70 | 58 | 60 | >170 |
| SOT - after 24 h @90° C. | 38 | 34 | NT | NT |
| TFT - after 24 h @90° C. | 51 | 65 | NT | NT |
| SOT - after 48 h @90° C. | 43 | >300 | 25 | NT |
| TFT - after 48 h @90° C. | 66 | >300 | 66 | NT |
| SOT -after 6 months at RT | Cured | >90 | >100 | NT |
| TFT -after 6 months at RT | in ctg | >90 | >100 | NT |

Not all possible tests are performed on each and every formulation. The abbreviation NT stands for “not tested”. Cured in ctg stands for “cured in cartridge”, i.e., during storage. In the case of each of C1 to C4 the compositions are non-functional after 6 months. The C1 composition cured in the cartridge and C2 and C3 took too long to provide a TFT to be practically useful.

Example C4 shows that a tin based catalyst alone does not yield an adequately curing sealant. One notices that accelerated ageing at high temperature does not predict the commercial viability of the sealant, none of the examples being able to withstand 6 months ageing at room temperature (20-23° C.).

Table 3 shows the cure time of C5 to C13 using accelerated ageing at 50° C. as well as shelf-life (storage stability) measured at 6, 9 and 12 months (1 yr) under laboratory storage conditions.

TABLE 3
SOT and TFT measurements of comparative examples (minutes)
after various periods of ageing as indicated:

| | C5 | C6 | C7 | C8 | C9 | C10 | C11 | C12 | C13 |
|---|---|---|---|---|---|---|---|---|---|
| SOT- (initial) | 16 | 15 | 9 | 12 | 14 | 13 | 14 | 15 | 10 |
| TFT-(initial) | 30 | 42 | 23 | 30 | 22 | 21 | 25 | 27 | 14 |
| SOT 2 wk @ 50° C | 26 | 12 | 11 | 16 | 16 | 13 | 29 | 18 | 11 |
| TFT- 2 wk @ 50° C. | 45 | 37 | 20 | 29 | 32 | 32 | 45 | 39 | 15 |
| SOT -4 wk @ 50° C. | 37 | 20 | 17 | 30 | 37 | 50 | 56 | 54 | 28 |
| TFT -4 wk @ 50° C. | 64 | 64 | 60 < 90 | 83 | 58 | 64 | >127 | 92 | 41 |
| SOT 6 wk @ 50° C. | NT | NT | >100 | NT | NT | NT | 60 < 120 | 60 < 86 | ~56 |
| TFT 6 wk @ 50° C | NT | NT | >190 | NT | NT | NT | 150 | 140 | 77 |
| SOT 6 m RT | 29 | 80 | 60 | 60 | NT | NT | 150 | 120 | 80 |
| TFT 6 m RT | >123 | >180 | >180 | 140 | NT | NT | 210 | 140 | 105 |
| SOT 9 m RT | NT | NT | NT | NT | ~180 | ~180 | >360 | >360 | >360 |
| TFT 9 m RT | NT | NT | NT | NT | ~240 | ~240 | >360 | >360 | >360 |
| SOT 1 y RT | >195 | ~300 | >240 | ~300 | NT | NT | NT | NT | NT |
| TFT 1 y RT | >300 | >300 | >240 | ~300 | NT | NT | NT | NT | NT |

For values in the above Table prefixed with > the composition being tested had a SOT and/or TFT after the period indicated but no further measurements were made. The term in > e.g., >195 in Table 3 means that the value of SOT or TFT was greater than 195 minutes. Similarly, the term 60 < 90 indicates that the SOT or TFT test was undertaken after 60 minutes and 90 minutes and that the SOT or TFT was somewhere between the two.

It can be seen that none of these features 9 months of storage stability. Although C5 to C10 seems to withstand the accelerated ageing of 4 wks at 50° C., their cure is substantially slower at 6 m of RT storage and ageing impacts the mechanical properties and adhesion.

Table 4 shows the mechanical properties of the comparative examples C5 to 13.

The ageing of the compositions described above consisted of storing cartridges of the sealant under the specified time and conditions. After the designated ageing period the composition or the cured product material resulting from cure of the composition were tested within 48 hours of the completion of the required ageing period. The initial properties were determined within 48 hours after mixing.

Mechanical properties were determined using either H-bar test pieces or dumbbell test pieces as indicated and described below.

For the H-bar test specimen a sample of the composition having the dimensions 12×12×50 mm was sandwiched between two substrates. The two substrates were both made of glass, both made of aluminium or one of glass and one of aluminium with dimensions 12×75 mm as stipulated ISO 8339 Second edition 2005 Jun. 15. Unless otherwise indicated the substrates used for the testing herein were one glass and one aluminum substrate. Such specimens are generally referred to in the industry as H-bars or H-pieces, this notation together with the abbreviation (HP) will be used throughout the examples below. Each specimen is cured for 28 Days at room temperature (20-23° C.) and approximately 50% relative humidity (RH).

Cured specimen were mechanically tested using a tensile traction test as described in ISO 8339 The tensile strength necessary to break the piece and elongation at break were recorded. The failure was visually observed and the percentage of the surface that corresponded to cohesive failure (CF) was quantified. The break parameters recorded e.g., tensile strength and Elongation at break are expressed in MPa and % respectively.

Cohesive failure (CF) is observed when a cured material breaks without detaching from a substrate to which it is adhered. Adhesive failure (AF) refers to the situation when the cured material detaches cleanly (i.e., peels off) from a substrate. In some cases, a mixed failure mode may be observed: where there is a mixture of AF and CF. In such a situation the proportions of surface displaying CF (% CF) and AF (% AF) behavior are determined with % CF+% AF=100%. The values listed in Table 4 below refer to the % CF observed.

For each test in Table 4 the reported values represent arithmetic means of 3 or 4 independent measurements. Samples showing less than 85% CF after a 28-day cure period were deemed to have failed the tensile testing. Cured materials, e.g., sealants were deemed stable if 75% of the tensile strength measured on H-bars is retained after ageing

TABLE 4
mechanical properties of comparative formulations measured
on H-bars. “Ageing” refers to the sealant

| | | | | | | | | |
|---|---|---|---|---|---|---|---|---|
| C5 | C6 | C7 | C8 | C9 | C10 | C11 | C12 | C13 |

Fresh sealant, 28 D cure

| | | | | | | | | | |
|---|---|---|---|---|---|---|---|---|---|
| CF (%) | 0 | 30 | 100 | 100 | 20 | 30 | 100 | 100 | 100 |
| Tensile Strength (MPa) | 0.12 | 0.22 | 0.52 | 0.47 | 0.21 | 0.2275 | 0.55 | 0.43 | 0.75 |
| Elongation at Break (%) | 25 | 73 | 182 | 126 | 45.25 | 43 | 134 | 234 | 163 |

4 wks Ageing, 28 D cure

| | | | | | | | | | |
|---|---|---|---|---|---|---|---|---|---|
| CF (%) | NT | NT | 0 | 0 | NT | NT | 100 | 100 | 100 |
| Tensile Strength (MPa) | NT | NT | 0.05 | 0.05 | NT | NT | 0.39 | 0.32 | 0.41 |
| Elongation at Break (%) | NT | NT | 8.5 | 9 | NT | NT | 150 | 178 | 700 |

None of the comparative cured materials made from comparatives C5 to C13 in Table 4 have good mechanical properties. C5, C6,C9 and C10 show inadequate initial adhesion, whereas C7 and C8 show a complete loss in adhesion upon ageing. It was found that in the case of comparatives C11, C12 and C13 adequate adhesion was retained but they suffered a severe loss of tensile strength, i.e., results were less than 75% of the initial value which is deemed inadequate.

Table 5 shows the mechanical properties of selected comparative formulation measured using dumbbell test pieces. 2 mm thick sheets were prepared for each sample and were then cured at room temperature (20-23° C.) and about 50% relative humidity for 7 days. Standard dumbbell shaped test pieces were then cut out of the sheets either immediately or after a suitable period of ageing and the mechanical properties of these specimens tested following ASTM D 412 -06. Shore A was tested as described in ASTM D 2240. The reported values represent average values of 4 or 5 independent measurements. Sealants were deemed stable if 75% of the tensile strength and hardness (Shore A) were retained upon ageing.

TABLE 5
Further Mechanical properties of C11,
C12 and C13 using dumbbell Test pieces

| | C11 | C12 | C13 |
|---|---|---|---|
| Shore A (initial) | 14.3 | 12.3 | 24.7 |
| Tensile Strength (MPa) (initial) | 1.54 | 1.7 | 1.72 |
| Max. Elongation (%) (initial) | 429 | 555 | 340 |
| Modulus @ 100% elongation (MPa) (initial) | 0.45 | 0.38 | 0.62 |
| Shore A (after 4 wks. @ 50° C.) | 6 | 6 | 16.7 |
| Tensile Strength (MPa) (after 4 wks. @ | 0.87 | 0.92 | 1.68 |
| 50° C.) | | | |
| Max. Elongation (%) (after 4 wks. @ | 440 | 527 | 416 |
| 50° C.) | | | |
| Modulus @ 100% elongation (MPa) (after | 0.32 | 0.32 | 0.51 |
| 4 wks. @ 50° C.) | | | |

It can be seen that C11, C12 and C13 all exhibit a severe loss in hardness and tensile strength.

TABLE 5b
provides a qualitative summary of the comparative formulations.

| | C5 | C6 | C7 | C8 | C9 | C10 | C11 | C12 | C13 |
|---|---|---|---|---|---|---|---|---|---|
| cure time retained | OK | OK | OK | OK | almost | almost | No | No | OK |
| 4 wks 50° C. | | | | | | | | | |
| cure time retained | almost | almost | almost | almost | NT | NT | No | No | No |
| 6 months RT | | | | | | | | | |
| cure time retained | NT | NT | NT | NT | NT | NT | NT | NT | NT |
| 9 months RT | | | | | | | | | |
| cure time retained | NT | NT | NT | NT | NT | NT | NT | NT | NT |
| 1 yr RT | | | | | | | | | |
| Mechanical | Fails | Fails | OK | OK | Fails | Fails | OK | OK | OK |
| properties @ start | | | | | | | | | |
| retained | NT | NT | No | No | NT | NT | No | No | No |
| mechanical | | | | | | | | | |
| properties 4 wks | | | | | | | | | |
| 50° C. | | | | | | | | | |

Table 6 shows the composition of inventive formulations, table 7 shows SOT and TFT time, whereas table 8 and 9 show the mechanical properties measured on dumbbells respectively.

Inventive examples E1, E2, E3, E4, containing DBA or TMG boosters are compositional analogues of C7, C8, C9,C10 the only difference being the inclusion of the respective booster molecule. One notices that the choice of appropriate booster affords sealants of adequate application properties.

TABLE 6
Composition of inventive formulations

| Ingredient | E1 | E2 | E3 | E4 | E5 | E6 |
|---|---|---|---|---|---|---|
| Polymer A | 27.422 | 27.397 | 27.397 | 27.523 | | |
| Polymer B | 59.414 | 59.362 | 59.362 | 59.633 | 86.754 | |
| Polymer C | | | | | | 84.653 |
| MTM | 1.463 | 1.461 | 1.461 | 1.468 | 1.461 | 1.693 |
| 1,6-bis(trimethoxysilyl)hexane | 0.366 | 0.365 | 0.365 | 0.367 | 0.365 | 0.423 |
| vinylmethyl-dimethoxysilane | 1.463 | 1.461 | 1.461 | 1.468 | 1.461 | 1.693 |
| Aerosil ®R 974 | 8.227 | 8.219 | 8.219 | 8.257 | 8.219 | 9.523 |
| HMDZ | 0.914 | 0.913 | 0.913 | 0.459 | 0.913 | 1.058 |
| DBTDL | 0.073 | 0.073 | 0.073 | 0.073 | 0.078 | 0.09 |
| Dibutylamine | 0.274 | 0.274 | | | | |
| Tetramethylguanidine | | | 0.274 | 0.275 | 0.274 | 0.317 |
| TnBT | 0.201 | 0.201 | 0.201 | 0.202 | 0.201 | 0.233 |
| Aminopropyl-triethoxysilane | 0.183 | 0.274 | 0.274 | 0.275 | 0.274 | 0.317 |

TABLE 7
SOT and TFT values (min) of inventive formulations
after various periods of ageing

| | E1 | E2 | E3 | E4 | E5 | E6 |
|---|---|---|---|---|---|---|
| SOT (initial) | 43 | 35 | 19 | 16 | 20 | 14 |
| TFT (initial) | 110 | 160 | 40 | 33 | 38 | 30 |
| SOT (after 2 wks. @ 50° C.) | 19 | 22 | 12 | 12 | 10 | 18 |
| TFT (after 2 wks. @ 50° C.) | 65 | 68 | 18 | 18 | 18 | 27 |
| SOT (after 4 wks. @ 50° C.) | 28 | 26 | 16 | 16 | 13 | 15 |
| TFT (after 4 wks. @ 50° C.) | 55 | 54 | 21 | 19 | 23 | 20 |
| SOT (after 6 months @ RT) | NT | <100 | 20 | 16 | NT | NT |
| TFT (after 6 months @ RT) | NT | <100 | 30 | 25 | NT | NT |
| SOT (after 9 months @ RT) | NT | NT | 15 | 17 | 13 | 10 |
| TFT (after 9 months @ RT) | NT | NT | 30 | 30 | 23 | 18 |
| SOT (after 1 year @ RT) | <100 | <100 | 20 | 23 | 9-15 | NT |
| TFT 1 (after 1 year @ RT) | <100 | <100 | 24 | 25 | 27-45 | NT |

One notices than all materials have an acceptable cure time after both 9 months and 1 year of room temperature (RT, 20-23° C.) storage.

TABLE 8
Mechanical properties of selected inventive formulations measured
on H-bars after various periods of ageing. Each test piece being
cured for 28 days before testing. “Ageing” refers to the
sealant composition stored in moisture tight cartridge at 50° C.

| | E2 | E3 | E4 | E5 | E6 |
|---|---|---|---|---|---|
| % CF (initial) | 95% | 90% | 95% | 100% | 100% |
| Tensile Strength (MPa) | 0.38 | 0.37 | 0.45 | 0.45 | 0.73 |
| (initial) | | | | | |
| Elongation max, % (initial) | 93 | 85 | 112 | 188 | 134 |
| % CF (after 2 wks Ageing) | NT | 100 | 100 | 100 | 100 |
| Tensile Strength (MPa) | NT | 0.37 | 0.35 | 0.39 | 0.75 |
| (after 2 wks Ageing) | | | | | |
| Elongation max, % (after 2 | NT | 85 | 86 | 152 | 131 |
| wks Ageing) | | | | | |
| % CF (after 4 wks Ageing) | NT | 100 | 100 | 100 | 100 |
| Tensile Strength (MPa) | NT | 0.48 | 0.35 | 0.46 | 0.63 |
| (after 4 wks Ageing) | | | | | |
| Elongation max, % (after 4 | NT | 157 | 87 | 188 | 104 |
| wks Ageing) | | | | | |
| % CF (after 1 year Ageing) | NT | 100% | 100% | NT | NT |
| Tensile Strength (MPa) | NT | 0.48 | 0.51 | NT | NT |
| (after 1 year Ageing) | | | | | |
| Elongation max, % (after 1 | NT | 152 | 149 | NT | NT |
| year Ageing) | | | | | |

Elongation max, % means elongation at break.

TABLE 9
Mechanical properties of E5 and E6
formulations measured on dumbbells

| | E5 | E6 |
|---|---|---|
| Shore A (initial) | 10.7 | 21 |
| Tensile Strength (MPa) (initial) | 1.65 | 1.38 |
| Elongation at break % (initial) | 531 | 455 |
| Modulus at 100% elongation (initial) | 0.37 | 0.38 |
| Shore A (after 2 weeks (wks.) @ 50° C.) | 12.3 | 23.7 |
| Tensile Strength (MPa) (after 2 wks. @ 50° C.) | 1.64 | 2.13 |
| Elongation at break % (after 2 wks. @ 50° C.) | 472 | 339 |
| Modulus at 100% elongation (after 2 wks. @ 50° C.) | 0.41 | 0.71 |
| Shore A (after 4 wks. @ 50° C.) | 12 | 24 |
| Tensile Strength (MPa) (after 4 wks. @ 50° C.) | 1.47 | 1.86 |
| Elongation at break % (after 4 wks. @ 50° C.) | 468 | 339 |
| Modulus at 100% elongation (after 4 wks. @ 50° C.) | 0.39 | 0.64 |

It can be seen that mechanical properties as well as adhesion (determined on H-bars) are well retained. Same holds for hardness (shore A) and tensile strength measured on dumbbells.

TABLE 10
shows a qualitative summary of the properties of E1 to E6

| | E1 | E2 | E3 | E4 | E5 | E6 |
|---|---|---|---|---|---|---|
| cure time retained 4 wks 50° C. | OK | OK | OK | OK | OK | OK |
| cure time retained 6 months RT | NT | OK | OK | OK | NT | NT |
| cure time retained 9 months RT | NT | NT | OK | OK | OK | OK |
| cure time retained 1 yr RT | OK | OK | OK | NT | NT | NT |
| mechanicals @ start | OK | OK | OK | OK | OK | OK |
| retained mechanical properties 4 wks 50° C. | NT | NT | OK | OK | OK | OK |

It can be seen that E1 and E2 were stable for 1 year at room temperature and they both satisfied the accelerated ageing at 50° C. for 4 weeks. E3 and E4 retain their mechanical properties upon 4 weeks of accelerated ageing at 50° C. E5 and E6 were stable for 1 year at room temperature and retained their mechanical properties after 4 weeks of accelerated ageing at 50° C.

Further examples E7 to 10 were prepared. Examples 9 and 10 show that this work with extended sealant compositions. Compositions are depicted in Table 11 and results are shown in Tables 12 and 13 below.

Table 11 shows the composition (all values in wt. %) of Examples 7, 8, 9 and 10 which were used to analyse the adhesiveness of compositions as disclosed herein.

| | E7 | E8 | E9 | E10 |
|---|---|---|---|---|
| Polymer B | 86.519 | 86.283 | 58.50 | |
| Polymer B-1 | | | | 56.42 |
| Aerosil ® R 974 | 8.196 | 8.174 | 9.00 | 9.10 |
| MTM | 1.457 | 1.453 | 1.44 | 2.00 |
| HMDZ | 0.911 | 0.908 | 0.90 | 1.00 |
| DBTDL | 0.077 | 0.077 | 0.08 | 0.08 |
| TMG | 0.273 | 0.272 | 0.27 | 0.30 |
| Polymer D | | | 27.00 | |
| Polymer E | | | | 30.20 |
| aminoethyl aminopropyl trimethoxy | 0.546 | | | 0.90 |
| silane (distilled) | | | | |
| aminoethyl aminopropyl trimethoxy | | 0.817 | 0.81 | |
| silane (technical grade, 20% impurities) | | | | |
| 1,6-bis(trimethoxysilyl)hexane | 0.364 | 0.363 | .36 | |
| vinylmethyl-dimethoxysilane | 1.457 | 1.453 | 1.44 | |
| TnBT | 0.200 | 0.200 | 0.20 | |

TABLE 12
SOT and TFT results for Examples 7,
8, 9 and 10(E7, E8, E9 and E10)

| | E7 | E8 | E9 | E10 |
|---|---|---|---|---|
| SOT (initial) | 15 | 5-15 | 24 | 8 |
| TFT (initial) | 60-80 | 65 | 75 | 29 |
| SOT (after 4 wks. @ 50° C.) | 10 | 24 | 15 | 18 |
| TFT(after 4 wks. @ 50° C.) | 55-75 | 47 | 22 | 41 |
| SOT (after 6 wks. @ 50° C.) | 51 | 60 | 20 | 19 |
| TFT(after 6 wks. @ 50° C.) | 87 | 140 > 170 | 120 | 45-55 |

It can be seen form Table 12 that E7, E8, E9 and E10 all satisfied the accelerated ageing of 6 weeks at 50° C. E7, E8, E9 and E10 were tested to determine their adhesion to polyvinyl chloride (PVC). White PVC substrates having dimensions of 15 by 7.5 cm were prepared by cleaning with isopropanol 5 to 10 minutes before extruding a “finger” of silicone along the longer side of the substrate Immediately upon extrusion, the finger was gently pressed with a spatula to form a test specimen of approx. 1 cm width and 5-8 mm thickness. These samples were stored at room temperature and 50% relative humidity (RH). At regular intervals an undercut close to the PVC substrate was done in a direction perpendicular to the sealant “finger”. The resulting loose end produced was then manually pulled for a couple of cm. The results are an average of two tests. The sealant was deemed to adhere to PVC if the pulling on the finger results in the break within the sealant without detachment from the substrate for at least 50% of the initially covered PVC surface.

TABLE 13
Adhesion to PVC

| | E7-E10 |
|---|---|
| Finger peel cured 7 Days (initial) | 100% CF |
| Finger peel cured 14 Days (initial) | 100% CF |
| Finger peel cured 21 Days (initial) | 100% CF |
| Finger peel cured 28 Days (initial) | 100% CF |
| Finger peel cured 7 Days (after 4 wks. ageing at 50° C.) | 100% CF |
| Finger peel cured 14 Days (after 4 wks. ageing at 50° C.) | 100% CF |
| Finger peel cured 21 Days (after 4 wks. ageing at 50° C.) | 100% CF |
| Finger peel cured 28 Days (after 4 wks. ageing at 50° C.) | 100% CF |

In each instance E7 to E10 all resulted in 100% cohesive failure, together with commercially exploitable stability.

1. A one-part condensation curable room temperature vulcanisable (RTV) silicone composition comprising:
(a) an organopolysiloxane polymer having at least two hydroxyl or hydrolysable groups per molecule of the formula
X₃₋ₙRₙSi-(Z)_{d}-(O)_{q}—(R¹_{y}SiO_{(4-y)/2})_{z}—(SiR¹₂₋Z)_{d}-Si—RₙX₃₋ₙ (1)
in which each X is independently a hydroxyl group or a hydrolysable group, each R is an alkyl, alkenyl or aryl group, each R¹ is an X group, alkyl group, alkenyl group or aryl group and Z is a divalent organic group;
d is 0 or 1, q is 0 or 1, and (d+q)=1; n is 0, 1, 2 or 3, y is 0, 1 or 2, optionally 2, and z is an integer such that the organopolysiloxane polymer has a viscosity of from 30,000 to 150,000 mPa·s at 25° C., optionally of from 40,000 to 140,000 mPa·s at 25° C., in an amount of from 35 to 90% by weight of the composition;
(b) one or more essentially anhydrous reinforcing filler(s);
(c) one or more cross-linker(s) in the form of a silicon containing compound having at least two, optionally at least three hydrolysable groups per molecule;
(d) a tin (iv) based condensation catalyst in an amount of from 0.001 to 0.1% by weight of the composition; and
(e) one or more low molecular weight linear or branched nitrogen containing compounds selected from amidines, guanidines and other alkyl amines and alkyl polyamines, in an amount of from 0.1 to 3.5% by weight of the composition.

2. The one-part room temperature vulcanisable (RTV) silicone composition in accordance with claim 1, wherein the organopolysiloxane polymer (a) is of the formula structure
X₃₋ₙRₙSi-(Z)-(R¹_{y}SiO_{(4-y)/2})_{z}—(SiR¹₂-Z)-Si—Si—RₙX₃₋ₙ
wherein n is 0 or 1 and each X is an alkoxy group.

3. The one-part room temperature vulcanisable (RTV) silicone composition in accordance with claim 1 wherein the reinforcing filler (b) comprises a hydrophobically treated essentially anhydrous fumed silica and/or a precipitated silica having a surface area of at least 50.0 m²/g measured using the BET method in accordance with ISO 9277:2010.

4. The one-part room temperature vulcanisable (RTV) silicone composition in accordance with claim 1 wherein the composition and resulting cured material are translucent and/or transparent.

5. The one-part room temperature vulcanisable (RTV) silicone composition in accordance with claim 1 wherein the tin (iv) condensation catalyst (d) is selected from one or more of tin triflates, dialkyltin compounds, selected from dimethyltin di-2-ethylhexanoate, dimethyltin dilaurate, di-n-butyltin diacetate, di-n-butyltin di-2-ethylhexanoate, dimethyltin dineodecanoate (DMTDN), di-n-butyltin dicaprylate, di-n-butyltin di-2,2-dimethyl octanoate, di-n-butyltin octanoate, di-n-butyltin dilaurate (DBTDL), di-n-butyltin distearate, di-n-butyltin dimaleate, di-n-butyltin dioleate, di-n-octyltin di-2-ethylhexanoate, di-n-octyltin di-2,2-dimethyl octanoate, di-n-octyltin dimaleate, di-n-octyl tin dilaurate, di-n-butyl tin oxide, carbomethoxyphenyl tin trisuberate, tin butyrate, butyltintri-2-ethylhexoate tin naphthenate, isobutyltintriceroate, tin octoate, triethyltin tartrate and di-n-octyl tin oxide.

6. The one-part room temperature vulcanisable (RTV) silicone composition in accordance with claim 1 wherein component (e) comprises linear or branched organic molecules containing one or more of the groups (1) to (4) depicted below: 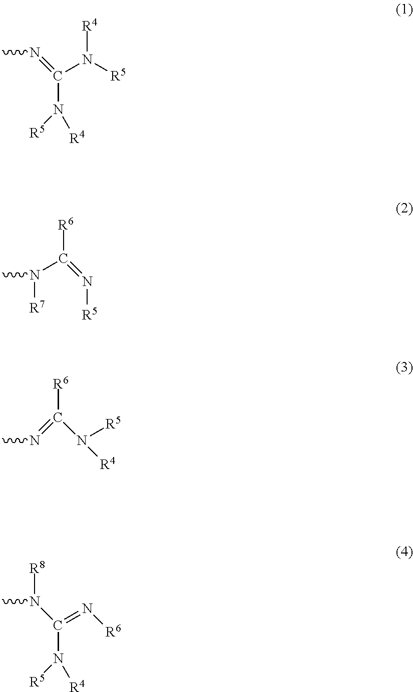
wherein each R⁴, R⁵, R⁶, R⁷ and R⁸ is the same or different and is selected from hydrogen, an alkyl group, a cycloalkyl group, a phenyl group, or an aralkyl group.

7. The one-part room temperature vulcanisable (RTV) silicone composition in accordance with claim 1 wherein component (e) comprises one of more of guanidine, tetramethyl guanidine, 1,1,3,3-tetramethylguanidine (TMG) having the structure (CH₃)₂N—C═NH(N(CH₃)₂), dibutyl amine, ethylene diamine, tri-ethylentertamine and diethylenetriamine.

8. The one-part room temperature vulcanisable (RTV) silicone composition in accordance with claim 1 capable of being applied as a paste to a joint between two adjacent substrate surfaces where it can be worked, prior to curing, to provide a smooth surfaced mass which will remain in its allotted position until it has cured into an elastomeric body adherent to the adjacent substrate surfaces.

9. The one-part room temperature vulcanisable (RTV) silicone composition in accordance with claim 1 which is adherable to poly vinyl chloride substrates.

10. A silicone elastomer which is the reaction product obtained by curing the one-part room temperature vulcanisable (RTV) silicone composition in accordance with claim 1.

11. The silicone elastomer in accordance with claim 10, which is transparent and/or translucent and/or non-staining.

12. A method of making the one-part room temperature vulcanisable (RTV) silicone composition in accordance with claim 1, comprising mixing all of the ingredients together.

13. A sealant comprising or formed from the one-part room temperature vulcanisable (RTV) silicone composition in accordance with claim 1, wherein the sealant is suitable for use in the facade, insulated glass, window construction, automotive, solar and construction fields.

14. A sealant comprising or formed from the one-part room temperature vulcanisable (RTV) silicone composition in accordance with claim 1.

15. A method for filling a space between two substrates so as to create a seal therebetween, comprising:
a) providing the one-part room temperature vulcanisable (RTV) silicone composition in accordance with claim 1, and either;
b) applying the one-part RTV silicone composition to a first substrate, and bringing a second substrate in contact with the one-part RTV silicone composition that has been applied to the first substrate, or
c) filling a space formed by the arrangement of a first substrate and a second substrate with the one-part RTV silicone composition and curing the one-part RTV silicone composition.

16. The method for filling a space between two substrates in accordance with claim 15, wherein the space is filled by introducing the one-part RTV silicone composition by way of extrusion or through a sealant gun and/or wherein one of the substrates is polyvinyl chloride (PVC).
